(19) United States
(12) Patent Application Publication
(10) Pub. No.: US 2008/0100539 A1
(43) Pub. Date: May 1, 2008

(54) PLASMA DISPLAY PANEL

(76) Inventors: Seongnam Ryu, Gumi-city (KR); Woogon Jeon, Gumi-city (KR); Wootae Kim, Gumi-city (KR); Kyunga Kang, Gumi-city (KR); Jeonghyun Hamh, Gumi-city (KR); Jaesung Kim, Gumi-city (KR)

Correspondence Address: KED & ASSOCIATES, LLP, P.O. Box 221200, Chantilly, VA, 20153-1200, US

(21) Appl. No.: 11/923,168

(22) Filed: Oct. 24, 2007

(30) Foreign Application Priority Data
Oct. 26, 2006 (KR) 10-2006-0104705

(51) Int. Cl. G09G 3/28

(52) U.S. Cl. 345/72

(57) ABSTRACT

A plasma display panel comprises a front substrate, a rear substrate, and a barrier rib. A first electrode and a second electrode are disposed in the front substrate. A third electrode intersecting the first electrode and the second electrode is disposed in the rear substrate. A barrier rib partitions at least one discharge cell between the front substrate and the rear substrate. At least one of the first electrode and the second electrode comprises a single layer, at least one of the first electrode and the second electrode comprises at least one line portion intersecting the third electrode and at least one protruded portion projecting from the line portion, and a shortest interval between the protruded portion and the barrier rib within the discharge cell is in a range of 5% to 40% of a width of the discharge cell, which is a shortest interval between the barrier ribs.

This application claims priority under 35 U.S.C. §119(a) on Patent Application No. 10-2006-0104705 filed in Republic of Korea on Oct. 26, 2006, the entire contents of which are hereby incorporated by reference.

### BACKGROUND

1. Field

This document relates to a plasma display panel.

2. Related Art

In general, in a plasma display panel, a phosphor layer and a plurality of electrodes are formed within a discharge cell partitioned by barrier ribs. If a driving signal is supplied to the discharge cell through the electrode, a discharge is generated by the supplied driving signal within the discharge cell.

When a discharge is generated by the driving signal within the discharge cell, a discharge gas charged within the discharge cell generates vacuum ultraviolet rays, and vacuum ultraviolet rays enable a phosphor formed within the discharge cell to emit light, whereby visible light is generated. An image is displayed on a screen of the plasma display panel by visible light.

### SUMMARY

An aspect of this document is to provide a plasma display panel that can improve driving efficiency and brightness of an image by improving a structure of at least one of a first electrode and a second electrode.

In one aspect, a plasma display panel comprises a front substrate in which a first electrode and a second electrode are disposed, a rear substrate in which a third electrode intersecting the first electrode and the second electrode is disposed and a barrier rib for partitioning at least one discharge cell between the front substrate and the rear substrate, wherein at least one of the first electrode and the second electrode comprises a single layer, at least one of the first electrode and the second electrode comprises at least one line portion intersecting the third electrode and at least one protruded portion projecting from the line portion, and a shortest interval between the protruded portion and the barrier rib within the discharge cell is in a range of 5% to 40% of a width of the discharge cell, which is a shortest interval between the barrier ribs.

In another aspect, a plasma display panel comprises a front substrate in which a first electrode and a second electrode are disposed, a rear substrate in which a third electrode intersecting the first electrode and the second electrode is disposed and a barrier rib for partitioning at least one discharge cell between the front substrate and the rear substrate, wherein at least one of the first electrode and the second electrode comprises a single layer, at least one of the first electrode and the second electrode comprises at least one line portion intersecting the third electrode and at least one protruded portion projecting from the line portion, a shortest interval between the protruded portion and the barrier rib within the discharge cell is in a range of 5% to 40% of a width of the discharge cell, which is a shortest interval between the barrier ribs, and a first ramp-down signal whose voltage value gradually falls in a negative direction and a ramp-up signal whose voltage value gradually rises in a positive direction are supplied to the first electrode.

In the plasma display panel, by forming at least one of the first electrode and the second electrode in a single layer, a manufacturing process is simplified and a manufacturing cost reduces.

Further, at least one of the first electrode and the second electrode comprises at least one line portion and at least one protruded portion, and by adjusting a shortest interval between the protruded portion and the barrier rib, driving efficiency of the plasma display panel improves and brightness of an image improves.

### BRIEF DESCRIPTION OF THE DRAWINGS

The details of one or more implementations are set forth in the accompanying drawings and the description below. In the entire description of this document, like reference numerals represent corresponding parts throughout various figures.

FIGS. 1 to 3 illustrate an example of a structure of a plasma display panel in an implementation;

FIG. 4 is a diagram explaining a reason that at least one of a first electrode and a second electrode is formed in a single layer.

FIG. 5 is a diagram explaining an example of a structure to which a black layer is added between the first electrode and the second electrode and a front substrate.

FIGS. 6 to 14 are diagrams illustrating a first example of a first electrode and a second electrode of a plasma display panel in an implementation;

FIGS. 15 and 16 are diagrams illustrating a second example of a first electrode and a second electrode of a plasma display panel in an implementation;

FIGS. 17 and 18 are diagrams illustrating a third example of a first electrode and a second electrode of a plasma display panel in an implementation;

FIGS. 19 and 20 are diagrams illustrating a fourth example of a first electrode and a second electrode of a plasma display panel in an implementation;

FIGS. 21 and 22 are diagrams illustrating a fifth example of a first electrode and a second electrode of a plasma display panel in an implementation;

FIG. 23 is a diagram illustrating a sixth example of a first electrode and a second electrode of a plasma display panel in an implementation;

FIG. 24 is a diagram illustrating an image frame for embodying a gray level of an image in a plasma display panel in an implementation;

FIG. 25 is a diagram illustrating an example of an operation of a plasma display panel in an implementation;

FIGS. 26 and 27 are diagrams illustrating another form of a ramp-up signal or a second ramp-down signal;

FIG. 28 is a diagram illustrating another type sustain signal;

FIG. 29 is a graph illustrating a relationship between a shortest interval between a protruded portion and a barrier rib and a shortest distance between the barrier ribs; and

FIG. 30 is a diagram illustrating a voltage change of a ramp-up signal according to the supply of a first ramp-down signal.

### DETAILED DESCRIPTION

Hereinafter, implementations of this document will be described in detail with reference to the accompanying drawings.

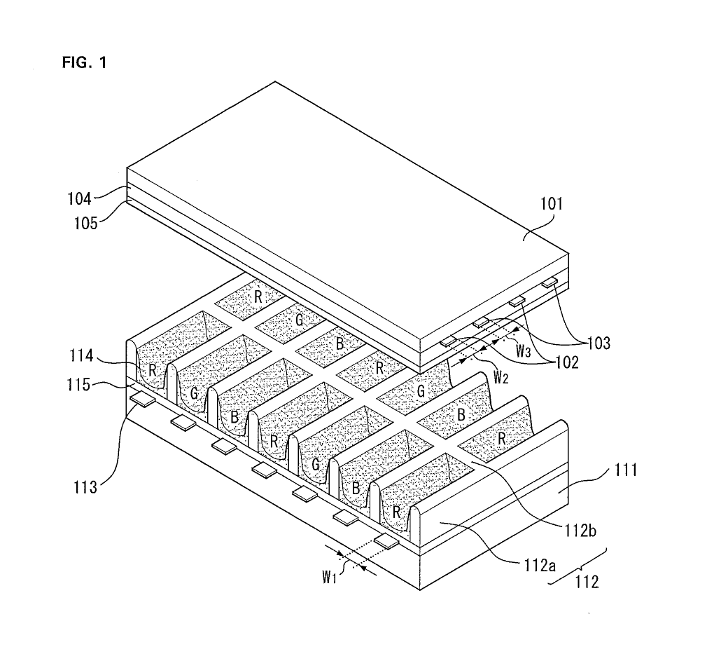

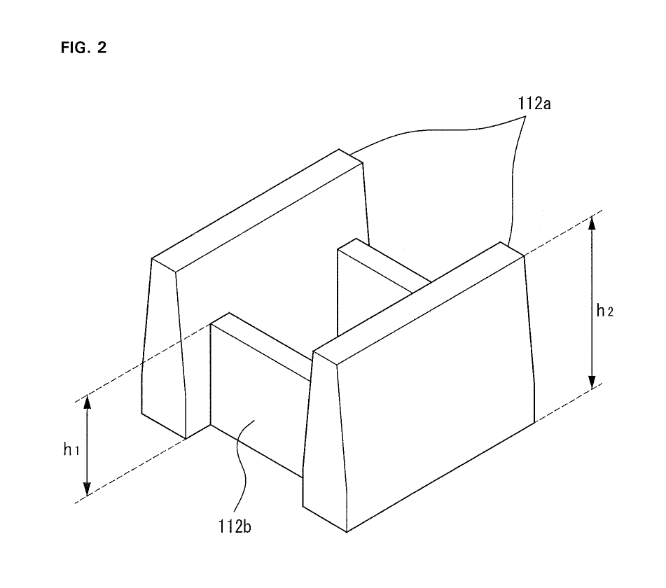

FIGS. 1 to 3 illustrate an example of a structure of a plasma display panel in an implementation.

The plasma display panel is formed by coupling a front substrate 101 in which a first electrode 102 and a second electrode 103 parallel to each other are disposed and a rear substrate ill in which a third electrode 113 intersecting the first electrode 102 and the second electrode 103 is disposed.

At least one of the first electrode 102 and the second electrode 103 is formed in a single layer. For example, at least one of the first electrode 102 and the second electrode 103 may be an electrode having an ITO-Less structure that does not comprise a transparent electrode.

At least one of the first electrode 102 and the second electrode 103 may comprise a metal material having electrical conductivity. For example, the metal material having electrical conductivity is made of silver (Ag), copper (Cu), aluminum (Al), etc. Because at least one of the first electrode 102 (Y) and the second electrode 103 (Z) comprises a metal material having electrical conductivity, a color of the at least one of the first electrode 102 (Y) and the second electrode 103 (Z) may be darker than that of an upper dielectric layer 104.

The first electrode 102 and the second electrode 103 receive a driving signal for generating or sustaining a discharge in a discharge cell.

The upper dielectric layer 104 for covering the first electrode 102 and the second electrode 103 is formed in an upper part of the front substrate 101 in which the first electrode 102 and the second electrode 103 are formed.

The upper dielectric layer 104 limits a discharge current of the first electrode 102 and the second electrode 103 and insulates the first electrode 102 and the second electrode 103 from each other.

As a magnesium oxide (MgO) and so on are deposited on the upper dielectric layer 104, a protective layer 105 is formed on the upper dielectric layer 104.

The third electrode 113 is positioned on the rear substrate 111, and a lower dielectric layer 115 for covering the third electrode 113 is formed in an upper part of the rear substrate 111 at which the third electrode 113 is positioned. The lower dielectric layer 115 isolates the third electrode 113.

A barrier rib 112 for partitioning a discharge space i.e. a discharge cell is positioned in the upper part of the lower dielectric layer 115, and an R discharge cell (R), a G discharge cell (G), a B discharge cell (B) are formed between the barrier ribs 112. The R, G, and B discharge cells are classified according to a color of light emitted from each discharge cell. Further, a discharge cell for emitting white color light or yellow color light in addition to the R discharge cell (R), the G discharge cell (G), and the B discharge cell (B) may be further formed.

Further, the plasma display panel in an implementation may have structures of barrier ribs having various shapes as well as a structure of the barrier rib 112 shown in FIG. 1. For example, the barrier rib 112 comprises a first barrier rib 112b and a second barrier rib 112a, and a height of the first barrier rib 112b may be different from that of the second barrier rib 112a. Further, a channel to be use as an exhaust passage may be formed in at lease one of the first barrier rib 112b and the second barrier rib 112a. A hollow may be formed in at lease one of the first barrier rib 112b and the second barrier rib 112a.

In the plasma display panel in an implementation, the R discharge cell (R), the G discharge cell (G), and the B discharge cell (B) are arranged in the same line, however the R discharge cell (R), the G discharge cell (G), and the B discharge cell (B) may not be arranged in the same line. For example, the R discharge cell (R), the G discharge cell (G), and the B discharge cell (B) may have a delta type arrangement in which the R discharge cell (R), the G discharge cell (G), and the B discharge cell (B) are arranged in a triangular shape. Further, the discharge cells may have various polygonal shapes such as a pentagonal shape and a hexagonal shape as well as a quadrangular shape.

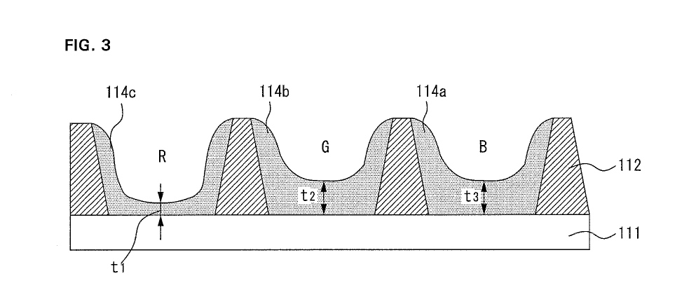

A phosphor layer 114 for emitting visible light upon generating a sustain discharge is formed within a discharge cell partitioned by the barrier rib 112. Further, a thickness of a phosphor layer in at least one of the R discharge cell (R), the G discharge cell (G), and the B discharge cell (B) may be different from that of a phosphor layer in the remaining discharge cells. For example, as shown in FIG. 3, thicknesses (t2, t3) of a green color phosphor layer 114b or a blue color phosphor layer 114a may be thicker than a thickness t1 of a red color phosphor layer 114c. The thickness t2 of the green color phosphor layer 114b may be substantially the same as or different from the thickness t3 of the blue color phosphor layer 114a. The thicknesses (t1, t2, and t3) of a layer of each phosphor are equal to a thickness in the center of the discharge cell.

The plasma display panel in an implementation is described, however this document is not limited thereto. For example, a black layer (not shown) for absorbing external light may be formed in an upper part of the barrier rib 112. Further, the black layer (not shown) may be formed in a specific position of the front substrate 101 corresponding to the barrier rib 112.

Further, although a width or a thickness of the third electrode 113 is substantially constant, a width or a thickness at the inside of a discharge cell may be different from a width or a thickness at the outside of the discharge cell. For example, a width or a thickness at the inside of the discharge cell may be wider than or thicker than a width or a thickness at the outside of the discharge cell.

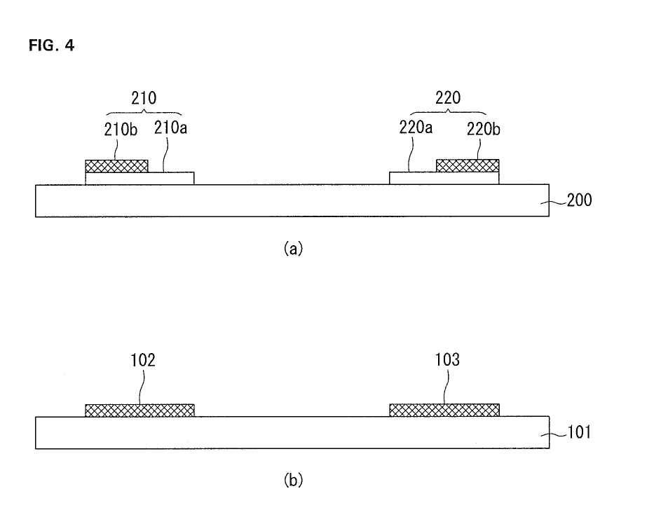

Referring to FIG. 4(a), unlike the implementation, a first electrode 210 and a second electrode 220 formed on a front substrate 200 are formed in a plurality of layers. For example, the first electrode 210 and the second electrode 220 may comprise transparent electrodes (210a, 220a) and bus electrodes (210b, 220b).

The transparent electrodes (210a, 220a) are made of indium-tin-oxide (ITO), and because indium-tin-oxide (ITO) is expensive, a manufacturing cost increases.

As shown in FIG. 4(b), if the first electrode 102 and the second electrode 103 are formed in a single layer, a manufacturing process is simplified and indium-tin-oxide (ITO) is not used, whereby a manufacturing cost of the plasma display panel reduces.

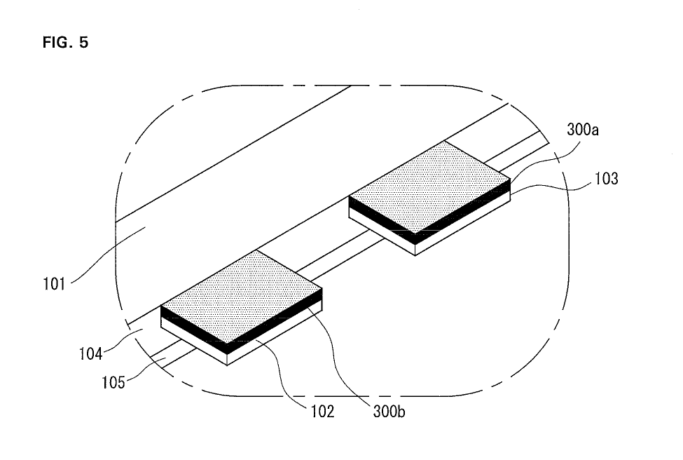

Referring to FIG. 5, black layers (300a, 300b) are formed between at least one of the first electrode 102 and the second electrode 103 and the front substrate 101. The black layers (300a, 300b) prevent discoloration of the front substrate 101 and have a color darker than that of at least one of the first electrode 102 and the second electrode 103.

If the black layers (300a, 300b) are provided between the front substrate 101 and the first electrode 102 and the second electrode 103, even if the first electrode 102 and the second electrode 103 are made of a material having a high reflectivity, generation of reflected light can be prevented.

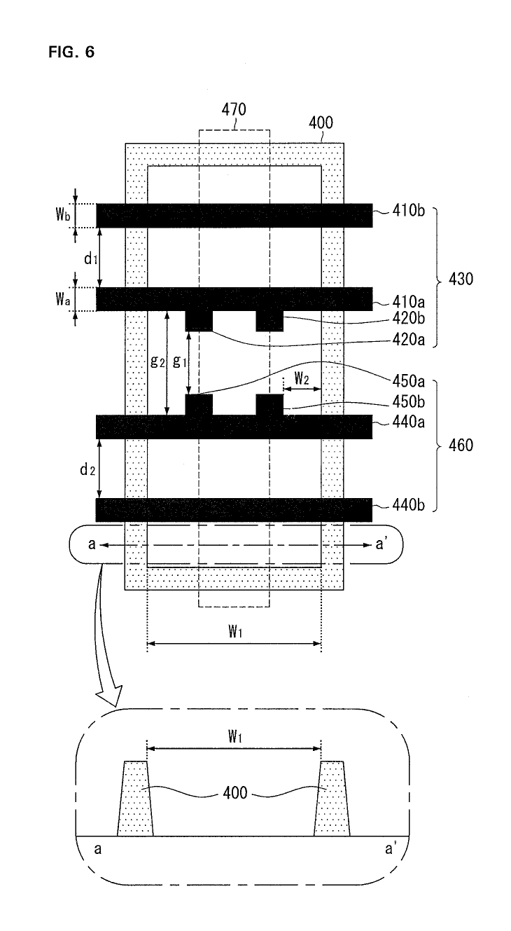

Referring to FIG. 6, at least one of the first electrode 430 and the second electrode 460 may comprise at least one line portion (410a, 410b, 440a, and 440b) . The line portions (410a, 410b, 440a, and 440b) intersect the third electrode 470 within a discharge cell partitioned by the barrier rib 400. Each of the line portions (410a, 410b, 440a, and 440b) is separated by a predetermined distance within the discharge cell.

For example, the first line portion 410a and the second line portion 410b of the first electrode 430 are separated by an interval ‘d1’, and the first line portion 440a and the second line portion 440b of the second electrode 460 are separated by an interval ‘d2’. The interval ‘d1’ may be substantially the same as or different from the interval ‘d2’.

The line portions (410a, 410b, 440a, and 440b) have predetermined widths (Wa, Wb). The first electrode 430 and the second electrode 460 may have a symmetrical shape or number or an asymmetrical shape or number within the discharge cell. At least one of the first electrode 430 and the second electrode 460 may comprise at least one protruded portion (420a, 420b, 450a, and 450b). The protruded portions (420a, 420b, 450a, and 450b) are protruded from the line portions (410a, 410b, 440a, and 440b). Further, the protruded portions (420a, 420b, 450a, and 450b) are disposed in parallel to a third electrode 470. For example, the protruded portions (420a, 420b) of the first electrode 430 is protruded from the first line portion 410a of the first electrode 430, and the protruded portions (450a, 450b) of the second electrode 460 is protruded from the first line portion 440a of the second electrode 460.

Because an interval g1 between the protruded portions (420a, 420b) of the first electrode 430 and the protruded portions (450a, 450b) of the second electrode 460 within the discharge cell is shorter than an interval g2 between the first electrode 430 and the second electrode 460 having no protruded portion, a discharge firing voltage between the first electrode 430 and the second electrode 460 is lowered.

A width W1 of the discharge cell is a shortest distance between top portions of the barrier rib 400 for partitioning a discharge cell, as shown in FIG. 6.

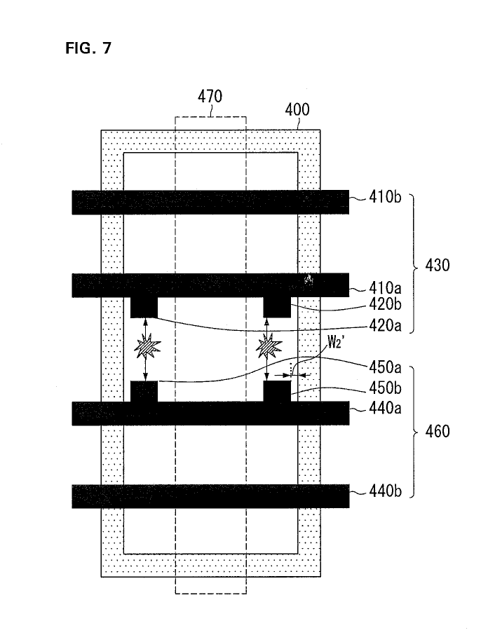

If a shortest interval W2 between each of the protruded portions (420a, 420b, 450a, and 450b) and the barrier rib 400 within the discharge cell is in a range of 5% to 40% of the width Wi of the discharge cell, visible rays generated within the discharge cell can be effectively emitted to the outside. For example, as shown in FIG. 7, when a shortest interval W2′ between the protruded portions (420a, 420b, 450a, and 450b) and the barrier rib 400 within the discharge cell is less than 5% of the width W1 of the discharge cell, because a discharge generating between the protruded portions (420a, 420b) of the first electrode 430 and the protruded portions (450a, 450b) of the second electrode 460 is leaned to an outer portion of the discharge cell, intensity of radiation of visible rays decreases, and brightness of an embodying image decreases.

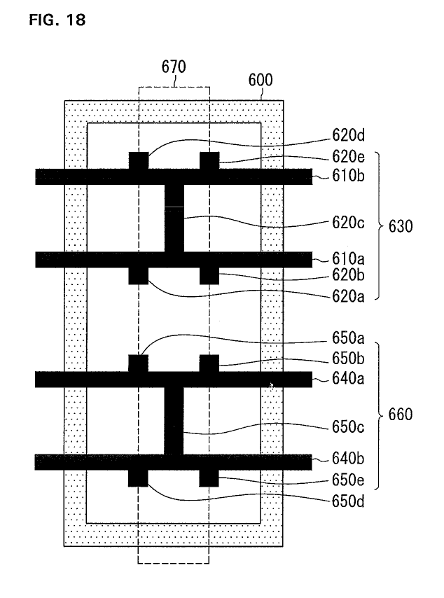

It is applied to the plasma display panel displayed in FIGS. 7 to 29 that a shortest interval W2 between the protruded portion (420a, 420b, 450a, and 450b) and the barrier rib 400 adjacent to the protruded portion (420a, 420b, 450a, and 450b) within the discharge cell is in a range of 5% 40% of the width W1 of the discharge cell.

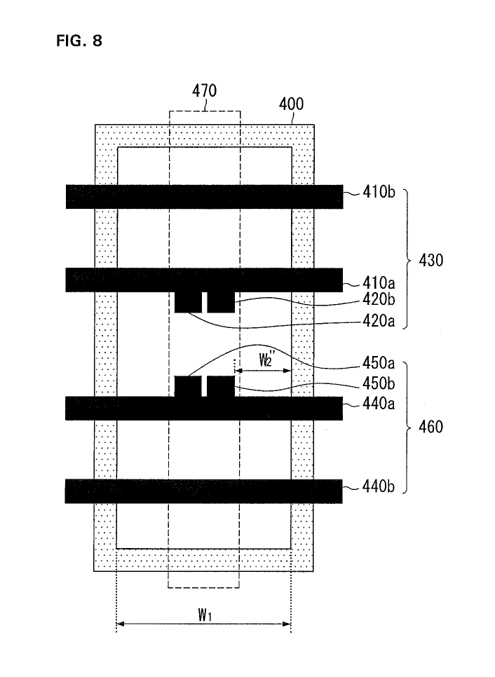

Further, as shown in FIG. 8, when a shortest interval W2″ between each of the protruded portions (420a, 420b, 450a, and 450b) and the adjacent barrier rib 400 within the discharge cell exceeds 40% of the width W1 of the discharge cell, the protruded portions (420a, 420b, 450a, and 450b) hide mainly a central portion of the discharge cell greatly contributing to brightness of the discharge cell. Therefore, brightness of the embodying image is lower than that in the structure of FIG. 6.

Further, as described with reference to FIG. 6, if a shortest interval W2 between the protruded portions (420a, 420b, 450a, and 450b) and the barrier rib 400 within the discharge cell is in range of 5% to 40% of the width W1 of the discharge cell, even if at least one of the first electrode 430 and the second electrode 460 is formed in a single layer, deterioration of driving efficiency can be prevented and deterioration of image brightness can be prevented.

Otherwise, a shortest interval W2 between the protruded portions (420a, 420b, 450a, and 450b) and the barrier rib 400 within the discharge cell may be in a range of 10% to 30% of the width W1 of the discharge cell. Accordingly, brightness of an embodying image can be further improved, and thus driving efficiency can be further improved.

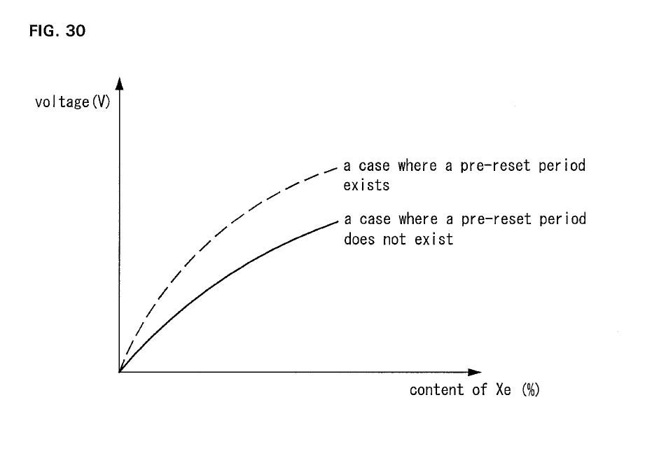

This is described in detail with reference to FIG. 30.

The protruded portions (420a, 420b, 450a, and 450b) may be overlapped with the third electrode 470 within the discharge cell. For example, as shown in FIG. 6, when the protruded portions (420a, 420b, 450a, and 450b) are formed in plural, at least one of a plurality of protruded portions (420a, 420b, 450a, and 450b) is overlapped with the third electrode 470 within the discharge cell. Accordingly, a discharge voltage between the first electrode 430 and the third electrode 470 and a discharge voltage between the second electrode 460 and the third electrode 470 can be lowered, and driving efficiency can be further improved.

A discharge generated between the protruded portions (420a, 420b) of the first electrode 430 and the protruded portions (450a, 450b) of the second electrode 460 opposite to each other can be diffused to the first line portion 410a and the second line portion 410b of the first electrode 430 and the first line portion 440a and the second line portion 440b of the second electrode 460.

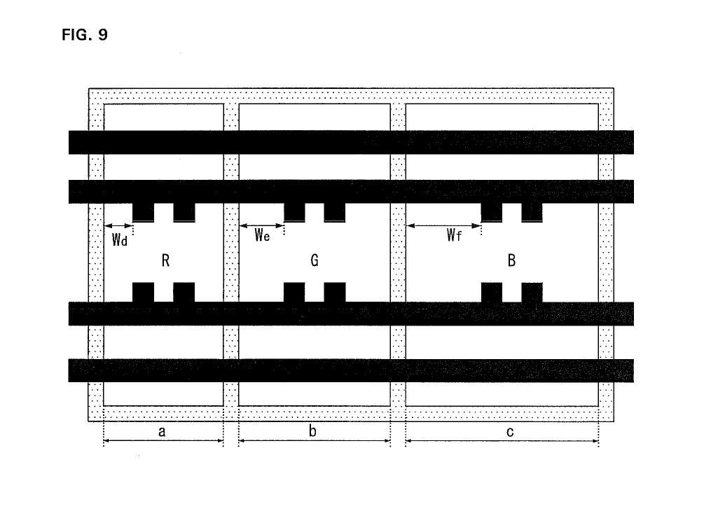

Referring to FIG. 9, at least one of widths (a, b, and c) of the R, G, and B discharge cells may be different from the remaining widths, For example, a width ‘a’ of the R discharge cell (R) may be smallest. Further, a width ‘c’ of the B discharge cell (B) may be greater than a width ‘b’ of the G discharge cell (G). Otherwise, the width ‘b’ of the G discharge cell (G) may be substantially equal to the width ‘c’ of the B discharge cell (B).

When widths of the discharge cells are different from each other, a width of a phosphor layer formed in the R, C, and B discharge cells changes in proportional to that of each discharge cell. By adjusting a width of the discharge cell and a width of the phosphor layer, color temperature characteristics of an image can be improved.

Further, if an interval between protruded portions within the R discharge cell (R), the G discharge cell (G), and the B discharge cell (B) is constant, a shortest interval Wf between the protruded portion and the barrier rib in the B discharge cell (B) may be greater than shortest intervals (Wd, We) between the protruded portion and the barrier rib in the G discharge cell (G) and the R discharge cell (R). Further, a shortest interval We between the protruded portion and the barrier rib in the C discharge cell (G) may be greater than a shortest interval Wd between the protruded portion and the barrier rib in the R discharge cell (R).

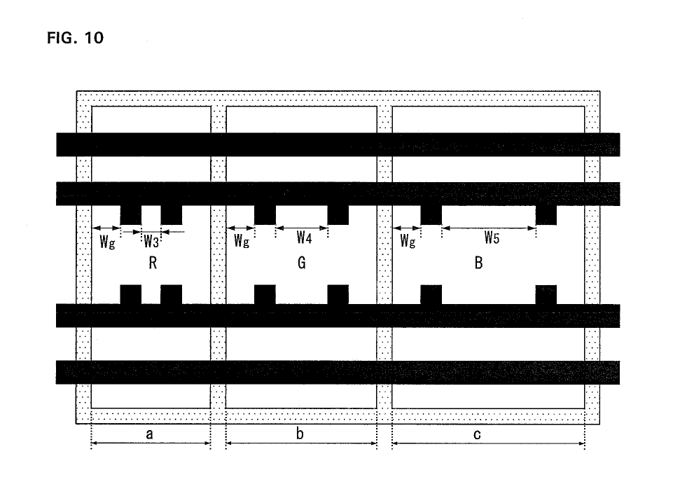

Shortest intervals between the protruded portion and the barrier rib in the B discharge cell (B), the G discharge cell (G), and the R discharge cell (R) may be substantially equal. For example, as shown in FIG. 10, intervals (W5, W4, and W3) between protruded portions in the R, G, and B discharge cells has a relationship of W5≧W4≧W3. In this case, in the R, G, and B discharge cells, shortest intervals Wg between the protruded portion and the adjacent barrier rib may be substantially equal.

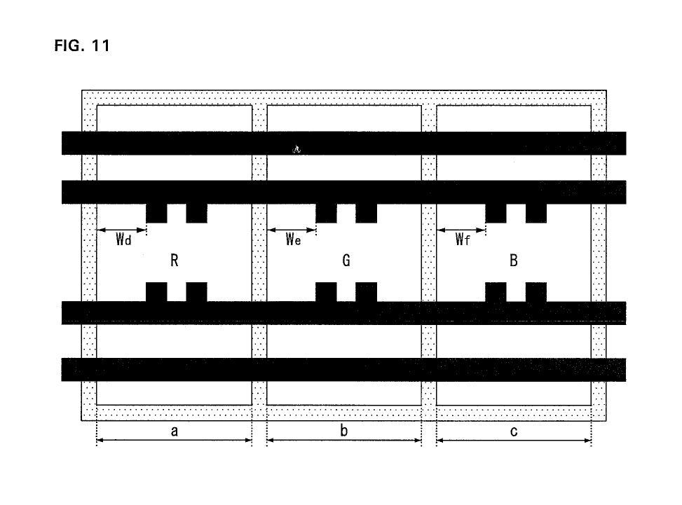

As shown in FIG. 11, shortest intervals (Wd, We, and Wf) between the protruded portions and the barrier ribs in a discharge cell (B) emitting blue color light, a discharge cell (G) emitting green color light, and a discharge cell (R) emitting red color light are substantially equal, and a width ‘c’ of the discharge cell (B) emitting green color light, a width ‘b’ of the discharge cell (G) emitting green color light, and a width ‘a’ of the discharge cell (R) emitting red color light are substantially equal. Accordingly, a barrier rib for partitioning the discharge cell can be easily formed.

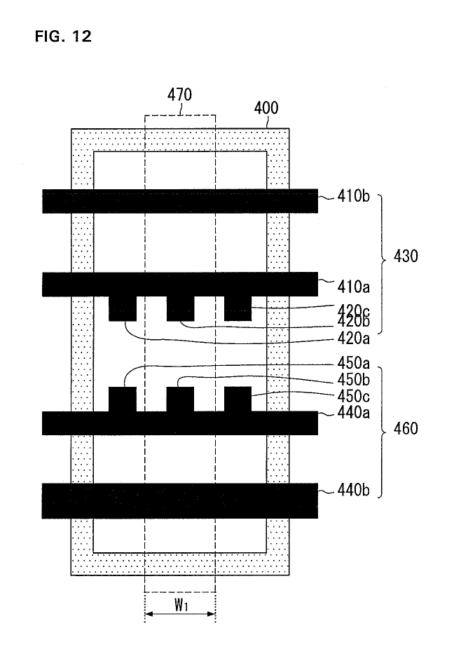

As shown in FIG. 12, the quantity of protruded portions of the first electrode 430 and the second electrode 460 may be greater than or smaller than two. A shortest interval between the protruded portions (420a, 420c, 450a, and 450c) and the barrier rib 400 of FIG. 12 may be 5% to 40% of the width of the discharge cell.

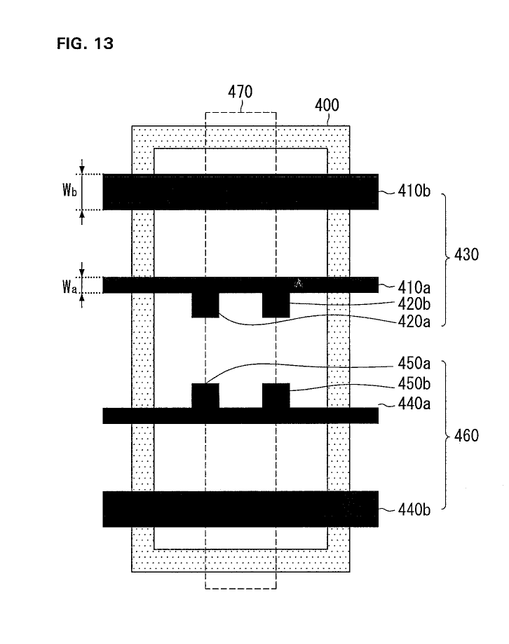

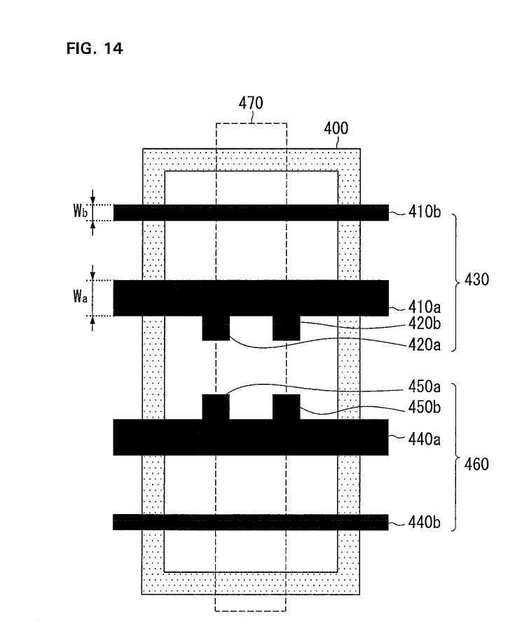

A width of at least one of a plurality of line portions (410a, 410b, 440a, and 440b) may be different from that of other line portions. For example, as shown in FIG. 13, a width Wa of the first line portion 410a of the first electrode 430 may be smaller than a width Wb of the second line portion 410b. Otherwise, as shown in FIG. 14, a width Wa of the first line portion 410a of the first electrode 430 may be greater than a width Wb of the second line portion 410b.

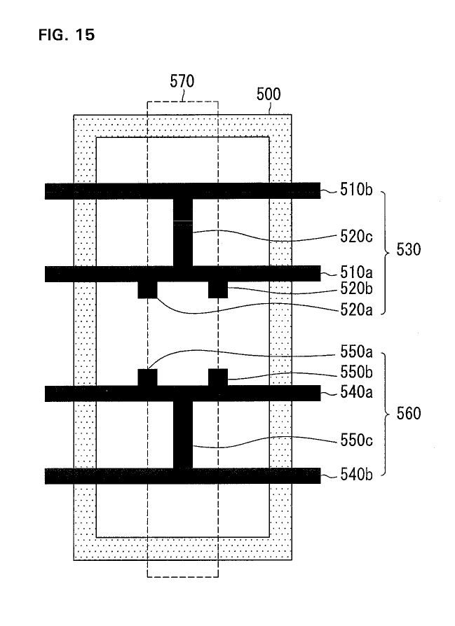

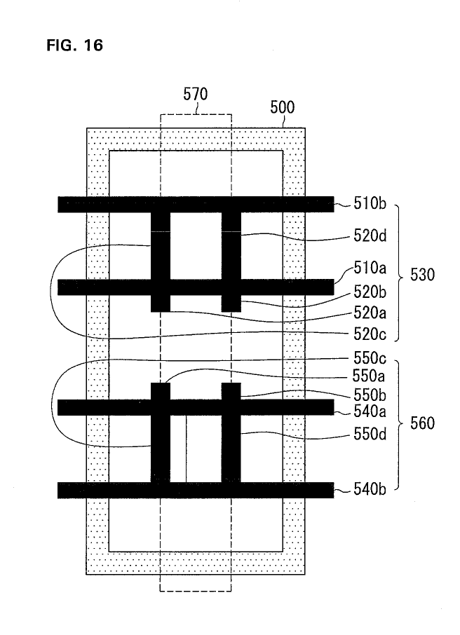

As shown in FIG. 15, connection parts (520c, 550c) for connecting at least two of a plurality of line portions (510a, 510b, 540a, and 540b) can be formed. For example, the connection part 520c of the first electrode 530 connects the first line portion 510a and the second line portion 510b of the first electrode 530, and the connection part 550c of the second electrode 560 connects the first line portion 540a and the second line portion 540b of the second electrode 560. If the connection parts (520c, 550c) connect two line portions (510a and 510b, or 540a and 540b), a discharge may be more easily diffused within the discharge cell. As shown in FIG. 16, the connection parts (520c, 520d) for connecting the first line portion 510a and the second line portion 510b of the first electrode 530 may be two or more. Such a connection part may be formed or may not be formed in the same line as that of the protruded portions.

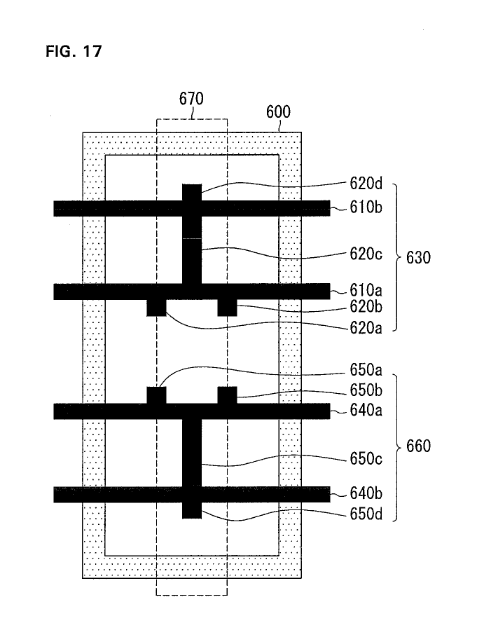

As shown in FIG. 17, at least one of a first electrode 630 and a second electrode 660 comprises a plurality of protruded portions (620a, 620b, 620d, 650a, 650b, and 650d), and may comprise first protruded portions (620a, 620b, 650a, and 650b) protruded in a first direction from at least one of a plurality of line portions (610a, 610b, 640a, and 640b) and second protruded portions (620d, 650d) protruded in a second direction, which is a direction opposite to the first direction. The first direction is a central direction of the discharge cell, and the second direction is an external direction of the discharge cell. The protruded portions (620a, 620b, 620d, 650a, 650b, and 650d) protruded in the first direction and the second direction facilitates diffusion of a discharge within the discharge cell.

In FIG. 17, one second protruded portion 620d protruded in the second direction is shown, however in order to further facilitate diffusion of a discharge in an external direction of the discharge cell, the quantity of the second protruded portions (620d, 650e) may be two or more.

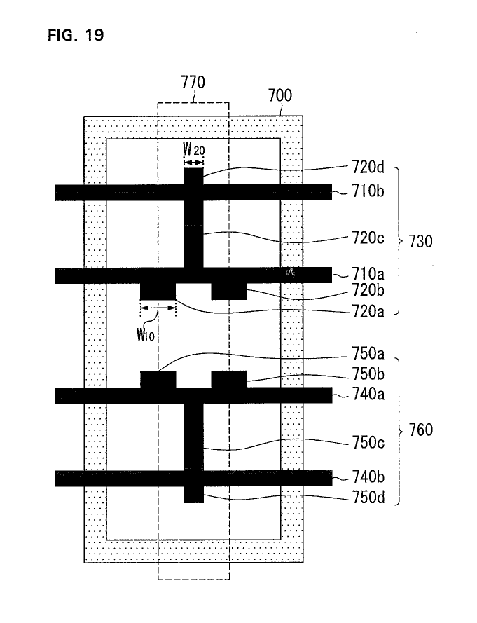

As shown in FIG. 19, a shape of the first protruded portions (720a, 720b, 750a, and 750b) may be different from that of the second protruded portions (720d, 750d). For example, a width W10 of the first protruded portions (720a, 720b, 750a, and 750b) may be greater than a width W20 of the second protruded portions (720d, 750d). If the width W10 of the first protruded portions (720a, 720b, 750a, 750b) is greater than the width W20 of the second protruded portions (720d, 750d), because a discharge firing voltage of the first electrode 730 and the second electrode 760 decreases and an area of opposite electrodes increases, intensity of a discharge increases.

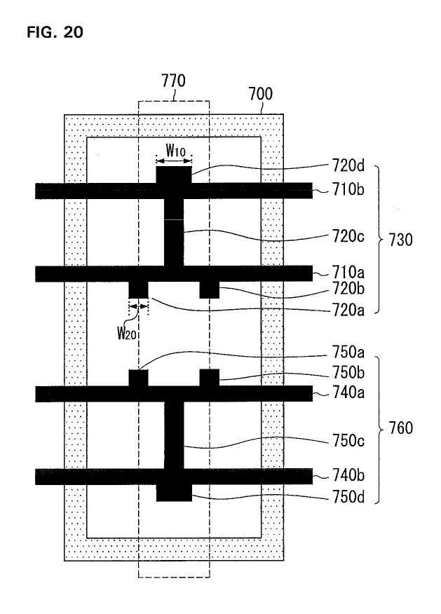

As shown in FIG. 20, the width W20 of the first protruded portions (720a, 720b, 750a, and 750b) may be smaller than the width W10 of the second protruded portions (720d, 750d). If the width W10 of the second protruded portions (720d, 750d) is greater than the width W20 of the first protruded portions (720a, 720b, 750a, and 750b), a discharge can be more effectively diffused to an outer portion of the discharge cell.

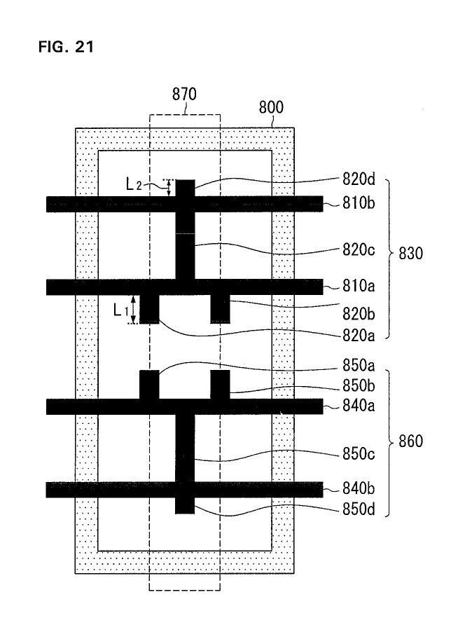

As shown in FIG. 21, a length of the first protruded portions (820a, 820b, 850a, and 850b) may be different from that of the second protruded portions (820d, 850d). For example, a length L1 of the first protruded portions (820a, 820b, 850a, and 850b) may be longer than a length L2 of the second protruded portions (820d, 850d). If the length L1 of the first protruded portions (820a, 820b, 850a, and 850b) is longer than the length L2 of the second protruded portions (820d, 850d), a discharge firing voltage between the first electrode 830 and the second electrode 860 can be lowered.

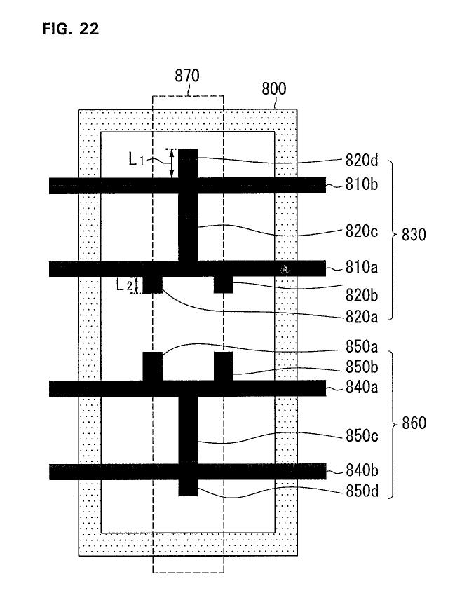

As shown in FIG. 22, the length L2 of the first protruded portions (820a, 820b, 850a, and 850b) may be shorter than the length L1 of the second protruded portions (820d, 850d). If the length L1 of the second protruded portions (820d, 850d) is longer than the length L2 of the first protruded portions (820a, 820b, 850a, and 850b), a discharge can be effectively diffused to an outer portion of the discharge cell.

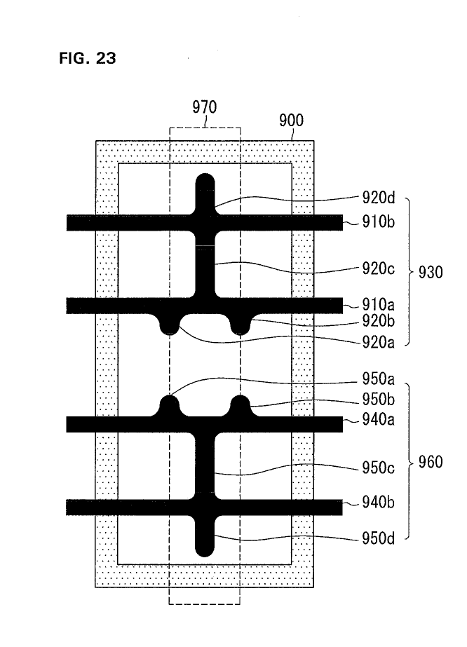

As shown in FIG. 23, at least one of a plurality of protruded portions (920a, 920b, 920d, 950a, 950b, and 950d) may have a curvature. Further, a portion to which the protruded portions (920a, 920b, 920d, 950a, 950b, and 950d) and the line portions (910a, 910b, 940a, and 940b) are connected may have a curvature. Further, a portion to which the line portions (910a, 91b, 940a, and 940b) and the connection parts (920c, 950c) are connected may have a curvature.

If a part of the first electrode or the second electrode has a curvature, a manufacturing process of the first electrode and the second electrode can be more easily performed. Further, by preventing that wall charges generated by a discharge while driving are excessively stacked at a specific position, for example a corner portion, reliability of driving improves.

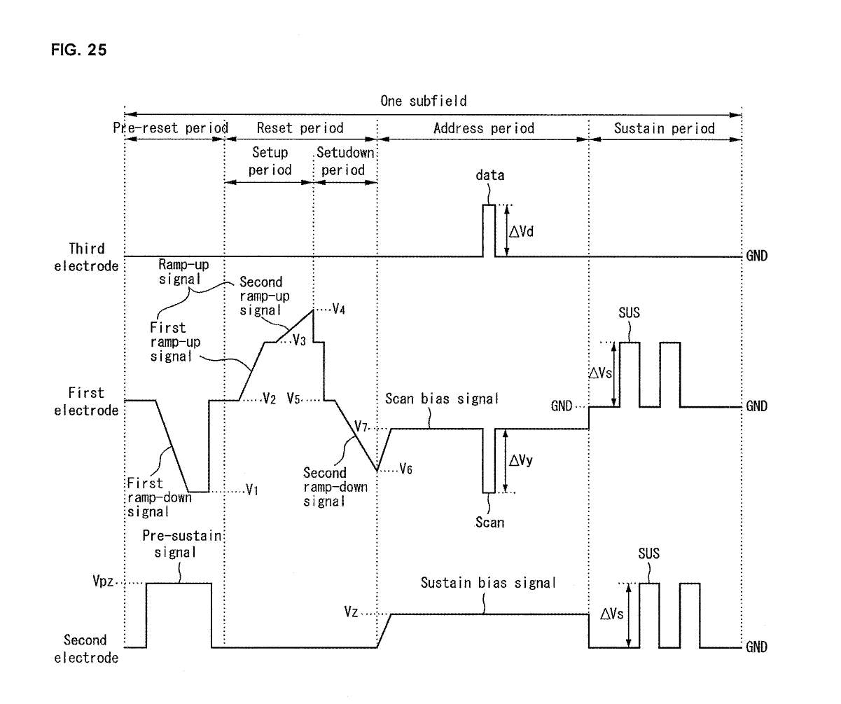

As shown in FIG. 25, in the plasma display panel, an image frame for embodying a gray level of an image is divided into a plurality of subfields having the different number of times of light emitting.

Further, although not shown, at least one of the plurality of subfields is divided into a reset period for initializing the discharge cell, an address period for selecting a discharge cell to be discharged, and a sustain period for embodying a gray level according to the number of times of a discharge.

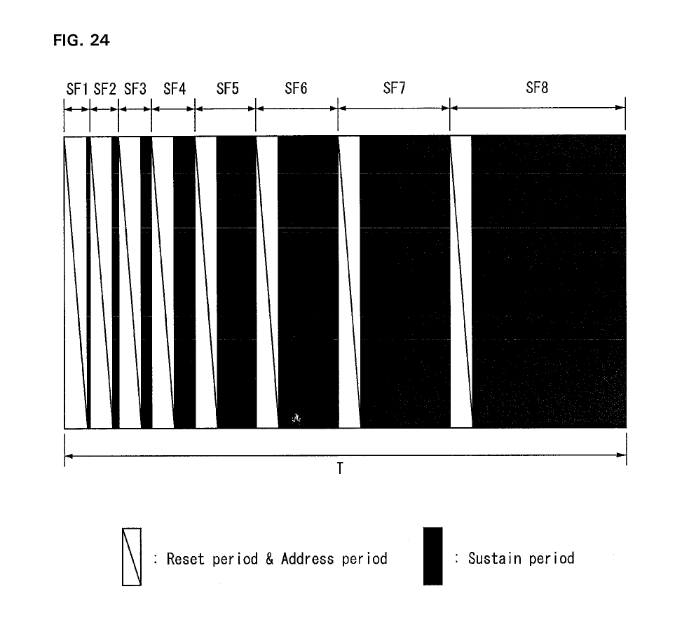

For example, an image frame is divided into 8 subfields (SF1 to SF8), and each of 8 subfields (SF1 to SF8) is subdivided into a reset period, an address period, and a sustain period, as shown in FIG. 24. In order to improve a driving margin or increase expression of a gray level, in at least one subfield, at least one of a reset period, an address period, and a sustain period may be omitted.

By controlling the quantity of sustain signals supplied in a sustain period, a gray level weight of the corresponding subfield can be set.

The plasma display panel uses a plurality of image frames in order to embody an image. For example, 60 image frames are used to display an image of 1 second. In this case, a length T of an image frame is 1/60 second, i.e. 16.67 ms.

Further, in FIG. 24, subfields are arranged in an increasing order of a gray level weight in one image frame, however subfields may be arranged in a decreasing order of a gray level weight or regardless of a gray level weight in one image frame.

As an example of a driving waveform of the plasma display panel, a first ramp-down signal can be supplied to the first electrode Y in a pre-reset period before a reset period, as shown in FIG. 25. While the first ramp-down signal is supplied to the first electrode Y, a pre-sustain signal having a polarity direction opposite to that of the first ramp-down signal can be supplied to the second electrode Z.

The first ramp-down signal supplied to the first electrode Y can gradually fall up to the first voltage V1. A pre-sustain signal can substantially uniformly sustain a pre-sustain voltage Vpz. The pre-sustain voltage Vpz is approximately equal to a voltage of a sustain signal SUS, i.e. a sustain voltage Vs to be supplied in a sustain period.

If the first ramp-down signal is supplied to the first electrode Y in a pre-reset period and a pre-sustain signal is supplied to the second electrode Z, wall charges of predetermined polarity are stacked on the first electrode Y and wall charges of polarity opposite to that of the first electrode Y are stacked on the second electrode Z.

Accordingly, because a setup discharge of enough intensity generates in a reset period, initialization can be stably performed. That is, as in an implementation, if at least one of the first electrode and the second electrode comprises a single layer such as a bus electrode, a driving voltage can increase, however a shortest interval between the protruded portion and the barrier rib within the discharge cell is in a range of 5% to 40% of a width of the discharge cell, which is a shortest distance between barrier ribs, and as a first ramp-down signal and a pre-sustain signal are supplied before a ramp-up signal is supplied, rising of a driving voltage of the plasma display apparatus can decrease. An effect due to the supply of the first ramp-down signal is described in detail with reference to FIG. 30.

A pre-reset period before a reset period is comprised in a subfield arranged at the first in a time order among subfields of an image frame or the first ramp-down signal before a reset period can be supplied in 2 or 3 subfields among subfields of an image frame. Further, a pre-reset period may be omitted in all subfields.

After a pre-reset period, a ramp-up signal of a polarity direction opposite to that of the first ramp-down signal is supplied to the first electrode Y in a setup period of a reset period for initialization.

The ramp-up signal comprises a first ramp-up signal gradually rising with a first slope from a second voltage V2 to a third voltage V3 and a second ramp-up signal rising with a second slope from the third voltage V3 to a fourth voltage V4.

A weak dark discharge, i.e. a setup discharge generates within the discharge cell by a ramp-up signal in a setup period. By the setup discharge, some wall charges are stacked within the discharge cell.

The second slope of the second ramp-up signal may be smoother than the first slope. If the second slope is smoother than the first slope, a quantity of light generating by a setup discharge is reduced. Accordingly, contrast characteristics can be improved.

In a setdown period after a setup period, after a ramp-up signal, a second ramp-down signal of a polarity direction opposite to that of the ramp-up signal can be supplied to the first electrode Y. The second ramp-down signal can gradually fall from a fifth voltage V5 to a sixth voltage V6.

Accordingly, a feeble erase discharge, i.e. a setdown discharge generates within the discharge cell. By the setdown discharge, wall charges to stably generate an address discharge uniformly remain within the discharge cell.

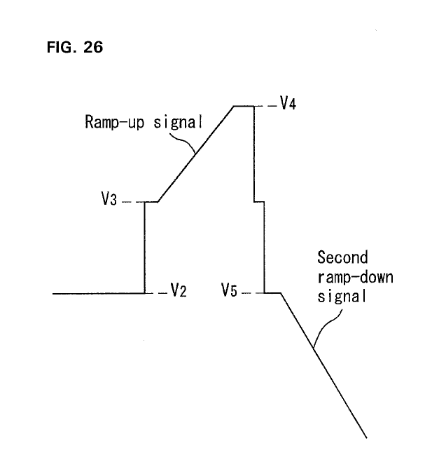

As shown in FIG. 26, after rapidly rising from the second voltage V2 to the third voltage V3, the ramp-up signal gradually rises from the third voltage V3 to the fourth voltage V4.

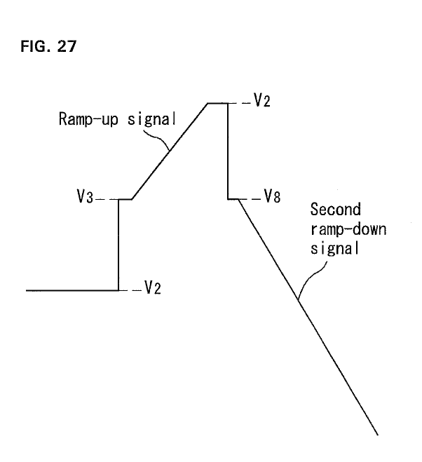

Referring to FIG. 27, in the second ramp-down signal, a voltage gradually falls from an eighth voltage V8. The eighth voltage V8 may be substantially equal to or different from the third voltage V3.

In an address period after a reset period, a scan bias signal for sustaining a voltage higher than a lowest voltage, i.e. a sixth voltage V6 of the second ramp-down signal can be supplied to the first electrode Y. A scan signal falling by a scan voltage ΔVy from a scan bias signal can be supplied to the first electrodes (Y1 to Yn).

A width of the scan signal may be varied with a subfield unit. That is, a width of the scan signal in at least one subfield may be different from that of a scan signal in other subfields. For example, a width of a scan signal in a subfield positioned at the back in a time order may be smaller than that of a scan signal in a subfield positioned at the front in a time order.

When a scan signal is supplied to the first electrode Y, a data signal rising by a magnitude ΔVd of a data voltage so as to correspond to the scan signal can be supplied to the third electrode X.

As the scan signal and the data signal are supplied, as a wall voltage by wall charges generated in a reset period is added to a voltage difference between a voltage of the scan signal and a data voltage Vd of the data signal, an address discharge can be generated within a discharge cell to which the voltage Vd of the data signal is supplied.

A sustain bias signal can be supplied to the second electrode Z in order to prevent that an address discharge becomes unstable by interference of the second electrode Z in an address period.

The sustain bias signal can substantially uniformly sustain a sustain bias voltage Vz smaller than a voltage of a sustain signal supplied in a sustain period and greater than a voltage of a ground level GND.

Thereafter, in a sustain period for displaying an image, a sustain signal SUS can be alternately supplied to at least one of the first electrode Y and the second electrode Z. If the sustain signal SUS is supplied, a display discharge is generated in a discharge cell selected by an address discharge.

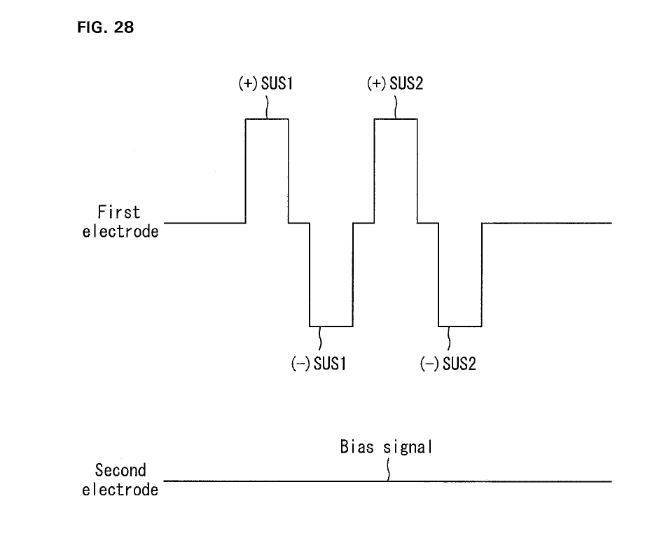

As shown in FIG. 28, a positive (+) sustain signal and a negative (−) sustain signal are alternately supplied to any one, for example, the first electrode among the first electrode Y and the second electrode Z.

While a positive sustain signal and a negative sustain signal are supplied to any one electrode, a bias signal having a voltage of a ground level can be supplied to the remaining electrode, for example the second electrode Z.

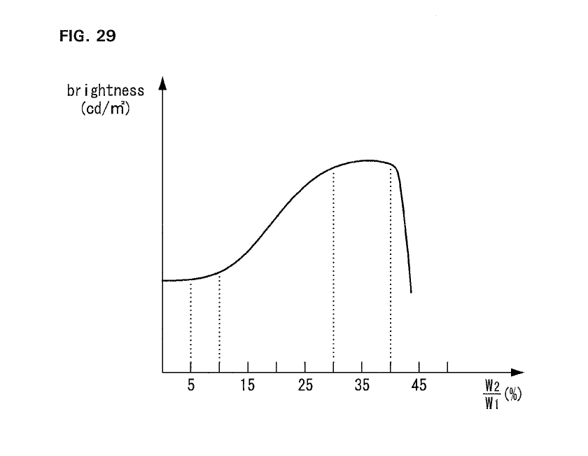

Referring to FIG. 6, a graph of FIG. 29 is described. When a shortest interval W2 between protruded portions (420a, 420b, 450a, and 450b) and the barrier rib 400 is in a range of 5% to 40% of the width W1 of the discharge cell, which is a shortest distance between the barrier ribs 400 within the discharge cell of FIG. 6 through the graph of FIG. 29, brightness increases. Particularly, when the shortest interval W2 between the protruded portions (420a, 420b, 450a, and 450b) and the barrier rib 400 is in a range of 10% to 30% of the width W1 of the discharge cell, brightness has a highest value.

FIG. 30 is a diagram illustrating a change of a highest voltage of a ramp-up signal according to whether a pre-reset period exists. When the first electrode and the second electrode comprise only a single layer such as a bus electrode, a graph of FIG. 30 shows a change of a highest voltage of a ramp-up signal according to a content of Xe within a plasma display panel according to whether or not existence of a pre-reset period described in FIG. 25. Particularly, FIG. 30 shows a change of a highest voltage of a ramp-up signal in a first subfield in which a pre-reset period is provided.

As shown in FIG. 30, as a content of Xe increases, a highest voltage of the ramp-up signal increases. In this case, when a pre-reset period exists, a highest voltage of the ramp-up signal is lower than that of a ramp-up signal having no pre-reset period.

Therefore, if a pre-reset period exists before a ramp-up signal is supplied, a driving voltage can be lowered, particularly when the first electrode or the second electrode comprises a single layer such as a bus electrode, a driving voltage is lowered by the supply of a pre-reset period, and thus a driving margin can be increased.

Other features will be apparent from the description and drawings, and from the claims.

What is claimed is:

1. A plasma display panel comprising:
a front substrate in which a first electrode and a second electrode are disposed;
a rear substrate in which a third electrode intersecting the first electrode and the second electrode is disposed; and
a barrier rib for partitioning at least one discharge cell between the front substrate and the rear substrate,
wherein at least one of the first electrode and the second electrode comprises a single layer,
at least one of the first electrode and the second electrode comprises at least one line portion intersecting the third electrode and at least one protruded portion projecting from the line portion, and
a shortest interval between the protruded portion and the barrier rib within the discharge cell is in a range of 5% to 40% of a width of the discharge cell, which is a shortest interval between the barrier ribs.

2. The plasma display panel of claim 1, wherein the shortest interval between the protruded portion and the barrier rib within the discharge cell is in a range of 10% to 30% of a width of the discharge cell.

3. The plasma display panel of claim 1, wherein at least one discharge cell comprises a discharge cell emitting blue color light, a discharge cell emitting green color light, and a discharge cell emitting red color light, and
a shortest interval between the protruded portion and the barrier rib in the discharge cell emitting blue color light is greater than that between the protruded portion and the barrier rib in the discharge cell emitting green color light and the discharge cell emitting red color light.

4. The plasma display panel of claim 1, wherein at least one discharge cell comprises a discharge cell emitting blue color light, a discharge cell emitting green color light, and a discharge cell emitting red color light,
shortest intervals between the protruded portions and the barrier ribs in the discharge cell emitting blue color light, the discharge cell emitting green color light, and the discharge cell emitting red color light are substantially equal, and
widths of the discharge cell emitting blue color light, the discharge cell emitting green color light, and the discharge cell emitting red color light are substantially equal.

5. The plasma display panel of claim 1, wherein at least one discharge cell comprises a discharge cell emitting blue color light, a discharge cell emitting green color light, and a discharge cell emitting red color light, and
a shortest interval between the protruded portion and the barrier rib in the discharge cell emitting green color light is greater than that between the protruded portion and the barrier rib in the discharge cell emitting red color light.

6. The plasma display panel of claim 1, wherein at least one discharge cell comprises a discharge cell emitting blue color light, a discharge cell emitting green color light, and a discharge cell emitting red color light, and
an interval between the protruded portions in the discharge cell emitting blue color light is greater than that between the protruded portions in the discharge cell emitting green color light and that between the protruded portions in the discharge cell emitting red color light.

7. The plasma display panel of claim 1, wherein the at least one line portion comprises a first line portion and a second line portion, and
widths of the first line portion and the second line portion are different from each other.

8. The plasma display panel of claim 1, further comprising a black layer positioned between the front substrate and at least one of the first electrode and the second electrode,
wherein a color of the black layer is darker than that of at least one of the first electrode and the second electrode.

9. The plasma display panel of claim 1, wherein a part of the protruded portion has a curvature.

10. The plasma display panel of claim 1, wherein at least one protruded portion projects in a central direction of the discharge cell, and
the plasma display panel further comprises at least one protruded portion protruded in a direction opposite to the central direction of the discharge cell.

11. The plasma display panel of claim 10, wherein a length of the protruded portion protruded in a central direction of the discharge cell is different from that of a protruded portion protruded in a direction opposite to a central direction of the discharge cell, or a width of the protruded portion protruded in a central direction of the discharge cell is different from that of a protruded portion protruded in a direction opposite to a central direction of the discharge cell.

12. The plasma display panel of claim 1, wherein at least one of the first electrode and the second electrode further comprises a connection part for connecting at least two of the line portions.

13. The plasma display panel of claim 12, wherein a portion to which the line portion and the connection part are connected has a curvature.

14. The plasma display panel of claim 1, wherein the protruded portion is overlapped with the third electrode.

15. The plasma display panel of claim 1, wherein at least one discharge cell comprises a discharge cell emitting blue color light, a discharge cell emitting green color light, and a discharge cell emitting red color light, and
a thickness of a phosphor formed in the discharge cell emitting blue color light is greater than that of phosphors formed in the discharge cell emitting green color light and the discharge cell emitting red color light.

16. A plasma display panel comprising:
a front substrate in which a first electrode and a second electrode are disposed;
a rear substrate in which a third electrode intersecting the first electrode and the second electrode is disposed; and
a barrier rib for partitioning at least one discharge cell between the front substrate and the rear substrate,
wherein at least one of the first electrode and the second electrode comprises a single layer,
at least one of the first electrode and the second electrode comprises at least one line portion intersecting the third electrode and at least one protruded portion projecting from the line portion,
a shortest interval between the protruded portion and the barrier rib within the discharge cell is in a range of 5% to 40% of a width of the discharge cell, which is a shortest interval between the barrier ribs, and
a first ramp-down signal whose voltage value gradually falls in a negative direction and a rampup signal whose voltage value gradually rises in a positive direction are supplied to the first electrode.

17. The plasma display panel of claim 16, wherein a positive pre-sustain signal is supplied to the second electrode while the first ramp-down signal is supplied.

18. The plasma display panel of claim 16, wherein the first ramp-down signal is supplied to a subfield in arranged at the first in a time order among a plurality of subfields constituting one frame.

19. The plasma display panel of claim 16, wherein after the ramp-up signal is supplied, a second ramp-down signal whose voltage value gradually decreases is supplied to the first electrode.

20. The plasma display panel of claim 19, wherein a lowest voltage of the second ramp-down signal is higher than a lowest voltage of the first ramp-down signal applied to the first electrode earlier than the second ramp-down signal.
